(19) United States
(12) Patent Application Publication
(10) Pub. No.: US 2007/0173193 A1
(43) Pub. Date: Jul. 26, 2007

(54) Dangerous Mail Handler

(76) Inventor: Richard Q. Li, Malvern, FL (US)

Correspondence Address: ADVANTIA LAW GROUP, 9035 SOUTH 1300 EAST, SUITE 200, SANDY, UT, 84094, US

(21) Appl. No.: 11/306,139

(22) Filed: Dec. 16, 2005

(51) Int. Cl. B08B 15/00

(52) U.S. Cl. 454/370

(57) ABSTRACT

A dangerous mail handler for the removal of dangerous particles from mail using a negative pressure generator and an adsorption compound for adsorbing the dangerous particles. The dangerous mail handler may comprise a hood in fluid connection with a battery of collectors each containing the adsorption compound. The negative pressure generator may be downstream from the battery of collectors and the hood. The hood may be clear. The hood may include ports lined with gloves for the manual handling of the mail.

### BACKGROUND OF THE INVENTION

1. Field of the Invention

The present invention relates to dangerous mail handlers, specifically dangerous mail handlers for the removal of dangerous particles from mail.

2. Description of the Related Art

In U.S. Patent Application Publication 2004/0140347 Mihaylov discloses a mailbox is developed which comprises a separated top and bottom port. A pivotally hinged gate/tray serves for depositing the incoming mail. The gate/tray has a pocket for outgoing mail and secures the top port from theft. Under the gate/tray a fixture with short wave ultraviolet (UV) light irradiates the box inside simultaneously generating ozone for a predetermined time. This time starts after the outgoing mail is put in the pocket or the incoming mail is dropped inside. A specially designed basket provides space around the mail where sanitizing gas freely diffuses. The light source can irradiate and activate gas-releasing objects generating other disinfecting gases such as chlorine, chlorine dioxide and ethylene oxide. The bottom port is closed by a locked door and allows retrieving the mail, and setting and maintaining the UV fixture. Two signals on an outside flag indicate the beginning and the end of the sanitizing process.

Simon, in U.S. Patent Application Publication 2003/0136824, discloses a mailbox for residential or business use that sanitizes mail deposited within it. The mailbox is equipped with one or more sanitizing devices such as a UV light, an ultra-sound unit, a heating element, and/or a misting device that dispenses a bactericidal mist.

Stemmle discloses in U.S. Patent Application Publication 2003/0132279 a method and system for sterilizing mail is provided. A mailbox is loaded with mail and closed. A decontamination process is performed over a predetermined period of time. An indicator communicates the status of the decontamination process.

Braun, in U.S. Patent Application Publication 2003/0127506 discloses a mailbox for decontaminating a mail parcel and the contents of the parcel. The mailbox comprises ultra-violet lamps operative to produce UV-C radiation and collateral ozone. The radiation destroys pathogens on the surface of the parcel and air circulating within the mailbox, as for instance driven by a fan in the mailbox, allows the ozone to penetrate the parcel envelope to contact the contents and destroy pathogens on the contents.

Finally Geisler discloses, in U.S. Pat. No. 6,872,927 systems and methods for neutralizing pathogen-contaminated mail pieces via variable frequency microwave processing. Mail pieces are initially screened to identify suspicious characteristics or indications of potentially harmful contents. Mail pieces are swept with variable frequency microwaves selected to neutralize pathogens contained within each mail piece without harming the mail piece or other contents thereof. The temperature of each mail piece may be monitored during microwave processing to identify mail pieces containing potentially harmful substances and/or devices. Mail pieces can be irradiated via additional forms of radiation to neutralize pathogenic material on outside surfaces thereof.

What is needed is a dangerous mail handler that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available dangerous mail handlers. According to one embodiment, the present invention has been developed to provide a dangerous mail handler for the removal of dangerous particles from mail, comprising: a desk module, which includes: a desk, a hood (the hood may be transparent), mounted on a top surface of the desk (which may be, for example, a stainless steel net or plate with holes), wherein the hood includes an access port to which a glove comprises a sealed attachment such that air inside the hood does not pass through the access port, and also at least one window, a particle collector, mounted below the desk and sealably attached to the hood, whereby the hood and the particle collector define a common space not divided by the desk, and a separator mounted between the hood and the particle collector, and comprising a series of apertures (which may be, for example, a plate with small holes or a net) allowing for the passage of particles from the hood to the particle collector, an adsorption battery for collection of particles, including: a first suction tube, fluidly connected to the particle collector, a first collection device, including an adsorption compound and a sealing plug, whereby the first suction tube passes through the sealing plug and into the adsorption compound, a second suction tube, fluidly connected to the first collection device by passing through the sealing plug but not in connection with the adsorption compound, a second collection device, including an adsorption compound and a sealing plug, whereby the second suction tube passes through the sealing plug and into the adsorption compound, and a third suction tube, fluidly connected to the first collection device by passing through the sealing plug but not in connection with the adsorption compound, and a negative pressure generator, fluidly connected to the third suction device.

The hood may be a substantially clear material. The adsorption compound may be activated carbon. The adsorption compound may be a liquid. The dangerous mail handler may further comprise an ultraviolet light attached to the hood. The dangerous mail handler may further comprise a second access port to which a glove comprises a sealed attachment such that air inside the hood does not pass through the access port. The hood may further include an air intake that allows gas to pass into the hood, but does not allow gas to pass out of the hood.

According to another embodiment of the present invention, the dangerous mail handler for the removal of dangerous particles from mail, consists only of: a desk module, which includes: a desk (which may include, for example, a stainless steel plate), a hood, mounted on a top surface of the desk, wherein the hood includes an access port to which a glove comprises a sealed attachment such that air inside the hood does not pass through the access port, and also at least one window, a particle collector, mounted below the desk and sealably attached to the hood, whereby the hood and the particle collector define a common space not divided by the desk, and a separator mounted between the hood and the particle collector, and comprising a series of apertures allowing for the passage of particles from the hood to the particle collector, an adsorption battery for collection of particles, including: a first suction tube, fluidly connected to the particle collector, a first collection device, including an adsorption compound and a sealing plug, whereby the first suction tube passes through the sealing plug and into the adsorption compound, a second suction tube, fluidly connected to the first collection device by passing through the sealing plug but not in connection with the adsorption compound, a second collection device, including an adsorption compound and a sealing plug, whereby the second suction tube passes through the sealing plug and into the adsorption compound, and a third suction tube, fluidly connected to the first collection device by passing through the sealing plug but not in connection with the adsorption compound, and a negative pressure generator, fluidly connected to the third suction device.

The hood may be a substantially clear material. The adsorption compound may be activated carbon. The adsorption compound may be a liquid.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates a perspective view of the dangerous mail handler according to one embodiment of the present invention; and

FIG. 2 illustrates the desk module of the dangerous mail handler according to one embodiment of the present invention.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

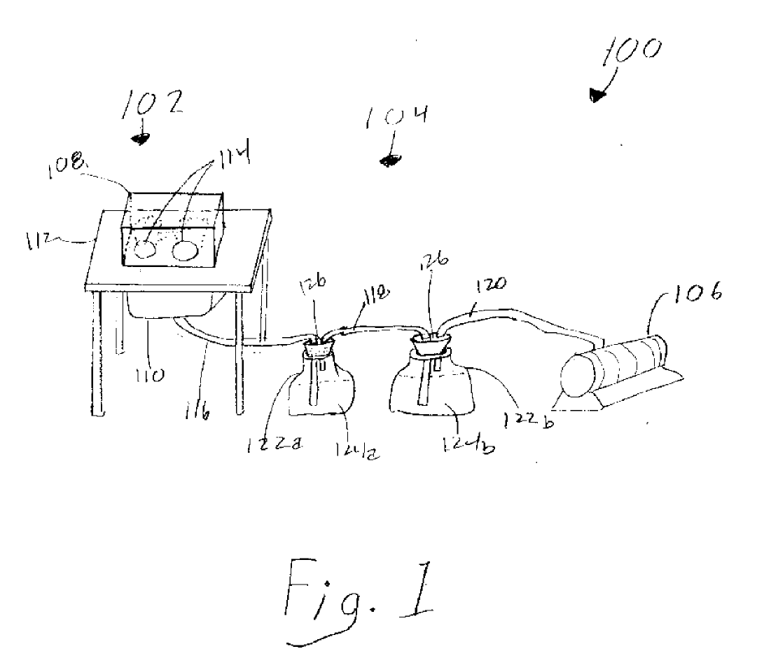

FIG. 1 illustrates a dangerous mail handler according to one embodiment of the present invention. The dangerous mail handler 100 of the present invention includes a desk module 102, an adsorption battery 104, and a negative pressure generator 106.

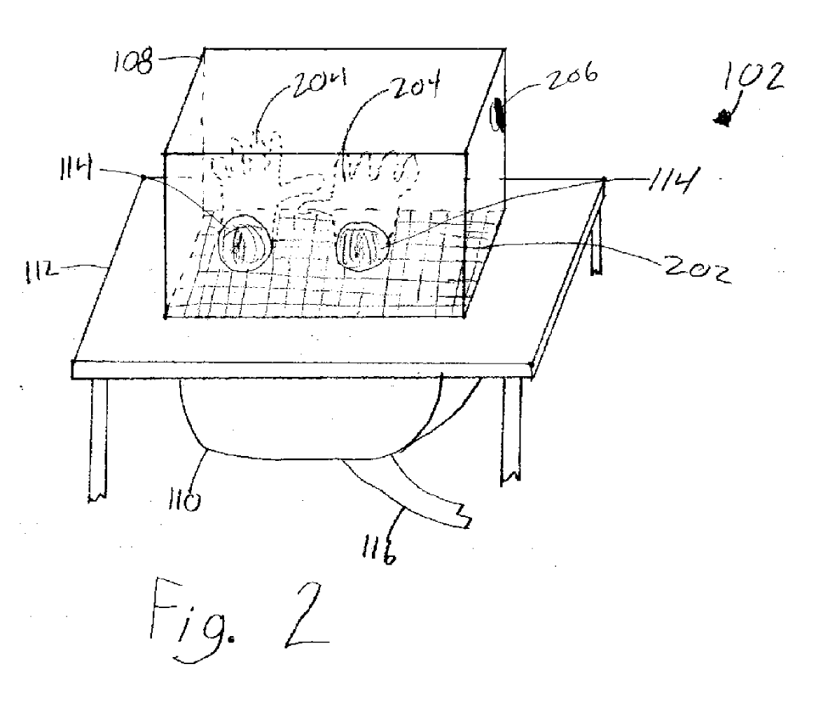

Turning to the desk module 102, which is illustrated in both FIGS. 1 and 2, the desk module 102 includes a desk 112. The desk 112 may be any device used to elevate the components of the desk module 102 above the floor. The desk 112 may be, for example, a desk, a table, a counter, a bench, a shelf, or so forth. The desk 112 may include a means for more easily moving the desk, such as wheels, casters, and the like. The desk 112 has an aperture through which the dangerous particles may pass. On the top surface of the desk 112, and covering the aperture is mounted a hood 108. The hood 108 and the aperture may be substantially the same size such that the hood 108 covers the aperture. The hood 108 may be mounted on the top surface of the desk 112 such that it may be removed. Such mounting may be by hinges or the like.

The hood 108 may be substantially fluid/gas impervious. The hood 108 may include a window such that the interior of the hood 108 may be seen from without the hood 108. In another embodiment, the hood 108 may be constructed of a transparent material, such as, for example, glass, plastic, composite, crystal, and so forth. The hood 108 may include a port 114 through which a person may put his hands to handle mail inside of the hood. The port 114 may be lined with a flexible material 204 that is substantially impervious to gas and dangerous particles. The flexible material 204 may be in the shape of a glove to facilitate easier handling of the mail inside of the hood 108. The hood 108 may include two ports 114 that are lined with the flexible material 204 for two-handed handling of the mail inside the hood 108.

In one embodiment, the hood 108 may include a one-way valve 206 to allow the passage of gas from without the hood 108 into the hood 108. This valve 206 would be necessary when, as discussed below, the negative pressure generator 106 creates a negative pressure inside the hood 108. Under negative pressure, if air is allowed, under control, to pass into the hood 108 through the valve 206, then a flow of air may help to sweep the dangerous particles into the adsorption battery 104.

Below the desk 112 may be mounted a particle collector 110. The particle collector 110 may be mounted over the aperture in the desk 112, and sealed to either the desk 112 or the hood 108 such that air does not pass from within the space defined by the hood 108 and the particle collector 110 to outside of the hood 108 or the particle collector 110. between the hood 108 and the particle collector 110 may be a separator 202. The separator 202 may include at least one aperture through which the particles may pass. The separator 202 may be a portion of the desk 112. In one embodiment, the separator 202 includes a screen or grate upon which mail may be placed, but through which the dangerous particles will pass. The particle collector 110 may also include another aperture on the bottom thereof for fluid connection to the adsorption battery 104.

The adsorption battery 104 is configured to adsorb the dangerous particles that are collected in the particle collector 110. The adsorption battery 104, or any part thereof, may be attached to the desk 112. In one embodiment, the adsorption battery 104, or a part thereof, may be attached to the particle collector 110. There may be a first suction tube 116 that is in fluid connection with the particle collector 110. This first suction tube 116 may then pass into a first collection device 122a. The first collection device 122a may include a sealing plug 126 and a first adsorption compound 124a. The first collection device 122a may be impervious to gas. The first collection device 122a may include one opening, into which the sealing plug 126 may be placed. The sealing plug 126 may include two apertures. Through one aperture may pass the first suction tube 116. This first suction tube 116 may pass through the sealing plug 126 and into the first adsorption compound 124a. A second suction tube 118 may pass through the second aperture of the sealing plug 126. The second suction tube 118 may not touch or pass into the first adsorption compound 124a.

The second suction tube 118 may then pass into a second collection device 122b The second collection device 122b may be set up similarly to the first collection device 122a. The second collection device 122b may include a sealing plug 126 and a second adsorption compound 124b. The second collection device 122b may be impervious to gas. The second collection device 122b may include one opening, into which the sealing plug 126 may be placed. The sealing plug 126 may include two apertures. Through one aperture may pass the second suction tube 118. This second suction tube 118 may pass through the sealing plug 126 and into the second adsorption compound 124b. A third suction tube 120 may pass through the second aperture of the sealing plug 126. The third suction tube 120 may not touch or pass into the second adsorption compound 124b. The third suction tube 120 may be fluidly connected to the negative pressure generator 106.

The adsorption compounds 124a and 124b may include compounds capable of adsorbing, neutralizing, or killing dangerous particles. The dangerous particles may be any that may be placed in mail packages. Some examples of dangerous particles may include, for example: viruses such as anthrax virus, various flu viruses (including avian flu virus, human flu viruses, and so forth), and so forth; bacterial agents; chemical agents; and so forth. The adsorption compounds 124a 124b may include, for example: activated carbon; acids; bases; alcohols; bleaches; and so forth. The first and second adsorption compounds 124a 124b may be the same or different adsorption compounds.

The negative pressure generator 106 may include any device capable of producing a negative pressure. In one embodiment, the negative pressure generator includes a vacuum pump. The negative pressure generator 106 and the dangerous mail handler 100 may be configured such that a negative pressure is generated through all of the suction tubes 116, 118, 120, the collection devices 122a 122b the hood 108 and the particle collector 110. The system may be configured with an air vent 206 in the hood 108 such that air flows from the air vent 206 to the hood 108, to the particle collector 110, to the first suction tube 116 to the first collection device 122a into the first adsorption compound 124a, to the second suction tube 118, to the second collection device 122b, into the second adsorption compound 124b to the third suction tube 120, and to the negative pressure device 106. The negative pressure device 106 may have an outlet such that the air flows out of the negative pressure device 106 into a controlled environment.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A dangerous mail handler for the removal of dangerous particles from mail, comprising:
a desk module, which includes:
a desk;
a hood, mounted on a top surface of the desk, wherein the hood includes an access port to which a glove comprises a sealed attachment such that air inside the hood does not pass through the access port, and also at least one window;
a particle collector, mounted below the desk and sealably attached to the hood, whereby the hood and the particle collector define a common space not divided by the desk; and
a separator mounted between the hood and the particle collector, and comprising a series of apertures allowing for the passage of particles from the hood to the particle collector;
an adsorption battery for collection of particles, including:
a first suction tube, fluidly connected to the particle collector;
a first collection device, including an adsorption compound and a sealing plug, whereby the first suction tube passes through the sealing plug and into the adsorption compound;
a second suction tube, fluidly connected to the first collection device by passing through the sealing plug but not in connection with the adsorption compound;
a second collection device, including an adsorption compound and a sealing plug, whereby the second suction tube passes through the sealing plug and into the adsorption compound; and
a third suction tube, fluidly connected to the first collection device by passing through the sealing plug but not in connection with the adsorption compound; and
a negative pressure generator, fluidly connected to the third suction device.

2. The dangerous mail handler of claim 1, wherein the hood is mounted to the top surface of the desk by hinges.

3. The dangerous mail handler of claim 1, wherein the hood comprises a substantially clear material.

4. The dangerous mail handler of claim 1, wherein the adsorption compound comprises activated carbon.

5. The dangerous mail handler of claim 1, wherein the adsorption compound comprises a liquid.

6. The dangerous mail handler of claim 1, further comprising an ultraviolet light attached to the hood.

7. The dangerous mail handler of claim 1, further comprising a second access port to which a glove comprises a sealed attachment such that air inside the hood does not pass through the access port.

8. The dangerous mail handler of claim 1, wherein the hood further comprises an air intake that allows gas to pass into the hood, but does not allow gas to pass out of the hood.

9. A dangerous mail handler for the removal of dangerous particles from mail, consisting of:
a desk module, which includes:
a desk;
a hood, mounted on a top surface of the desk, wherein the hood includes an access port to which a glove comprises a sealed attachment such that air inside the hood does not pass through the access port, and also at least one window;
a particle collector, mounted below the desk and sealably attached to the hood, whereby the hood and the particle collector define a common space not divided by the desk; and
a separator mounted between the hood and the particle collector, and comprising a series of apertures allowing for the passage of particles from the hood to the particle collector;
an adsorption battery for collection of particles, including:
a first suction tube, fluidly connected to the particle collector;
a first collection device, including an adsorption compound and a sealing plug, whereby the first suction tube passes through the sealing plug and into the adsorption compound;
a second suction tube, fluidly connected to the first collection device by passing through the sealing plug but not in connection with the adsorption compound;
a second collection device, including an adsorption compound and a sealing plug, whereby the second suction tube passes through the sealing plug and into the adsorption compound; and
a third suction tube, fluidly connected to the first collection device by passing through the sealing plug but not in connection with the adsorption compound; and
a negative pressure generator, fluidly connected to the third suction device.

10. The dangerous mail handler of claim 9, wherein the hood comprises a substantially clear material.

11. The dangerous mail handler of claim 9, wherein the adsorption compound comprises activated carbon.

12. The dangerous mail handler of claim 9, wherein the adsorption compound comprises a liquid.
